(19) United States
(12) Patent Application Publication
(10) Pub. No.: US 2016/0078298 A1
(43) Pub. Date: Mar. 17, 2016

(54) Surveillance Method and Camera System Using the Same

(71) Applicant: GeoVision Inc., Taipei (TW)

(72) Inventors: Chih-Ming Wu, New Taipei City (TW); Chun-Kai Hsu, New Taipei City (TW); Chun-Tao Lee, New Taipei City (TW); Hung-Jui Wang, Tainan City (TW)

(21) Appl. No.: 14/927,489

(22) Filed: Oct. 30, 2015

Related U.S. Application Data
(63) Continuation-in-part of application No. 14/487,108, filed on Sep. 16, 2014, now Pat. No. 9,208,668.

(51) Int. Cl. G06K 9/00; H04N 5/232; H04N 5/225

(52) U.S. Cl. CPC G06K 9/00771; H04N 5/2258; H04N 5/23296; H04N 5/23238; H04N 5/2259; H04N 5/2253

(57) ABSTRACT

A surveillance method is utilized in a camera system, wherein the camera system comprises a display device, a controller, a first camera disposed fixedly on a base of the camera system and constantly facing toward a first direction, and at least a second camera disposed on the base and controlled by the controller to rotate around the first camera. The surveillance method comprises the display device displaying a wide-angle image captured by the first camera; the controller receiving at least a directional instruction corresponding to at least a specific part of the wide-angle image; and the controller generating a plurality of control signals to steer the at least a second camera toward at least a second direction according to the at least a directional instruction.

### CROSS REFERENCE TO RELATED APPLICATIONS

This application is a continuation-in-part application of U.S. application Ser. No. 14/487,108 filed on Sep. 16, 2014.

### BACKGROUND OF THE INVENTION

1. Field of the Invention

The present invention relates to a surveillance method and a camera system, and more particularly, to a surveillance method and a camera system capable of monitoring a full view of an environment and providing a high resolution image of a part of the environment.

2. Description of the Prior Art

A surveillance system is extensively applied to the public place, such as the train station, the supermarket, the street, etc. A fisheye camera or a pan-tilt-zoom (PTZ) camera is applied to the conventional surveillance system. The fisheye camera is able to capture a wide-angle (wide-range) image of an environment. The PTZ camera is able to be panned, tilted and zoomed in/out to capture a high resolution image of a narrow-range of the environment. However, a capturing orientation of the fisheye camera is fixed and a resolution of the fisheye camera is relatively low. It is difficult for the fisheye camera to provide a clear vision of an object of interest in the environment. In addition, a field of view of the PTZ camera is narrow, compared to the fisheye camera, and thus, the object of interest is usually beyond the field of view of the PTZ camera. Therefore, it is necessary to improve the prior art.

### SUMMARY OF THE INVENTION

It is therefore a primary objective of the present invention to provide a surveillance method and a camera system capable of monitoring a full view of an environment and providing a high resolution image of a part of the environment, to improve over disadvantages of the prior art.

An embodiment of the present invention discloses a surveillance method, utilized in a camera system, the camera system comprising a display device, a controller, a first camera disposed fixedly on a base of the camera system and constantly facing toward a first direction, and at least a second camera disposed on the base and controlled by the controller to rotate around the first camera, the surveillance method comprising the display device displaying a wide-angle image captured by the first camera; the controller receiving at least a directional instruction corresponding to at least a specific part of the wide-angle image; and the controller generating a plurality of control signals to steer the at least a second camera toward at least a second direction according to the at least a directional instruction.

An embodiment of the present invention further discloses a camera system comprising a base; a first camera, disposed on the base, constantly facing toward a first direction, and configured to capture a wide-angle image; at least a second camera, disposed on the base, adjustably facing toward at least a second direction, and controlled to rotate around the first camera; a display device, coupled to the first camera and the at least a second camera, configured to display the wide-angle image; and a controller, coupled to the display device, the first camera and the at least a second camera, configured to generate a plurality of control signals to steer the at least a second camera toward at least a second direction according to at least a directional instruction.

An embodiment of the present invention further discloses a surveillance method, utilized in a camera system, the camera system comprising a controller, a first camera disposed fixedly on a base of the camera system and constantly facing toward a first direction, and at least a second camera disposed on the base and controlled to rotate around the first camera, the surveillance method comprising the first camera capturing a wide-angle image; the controller identifying at least an image object in the wide-angle image, where the at least an image object is corresponding to at least a moving object in an environment; and the controller generating a plurality of control signals to steer the at least a second camera such that the at least a moving object is within at least a field of view of the at least a second camera.

An embodiment of the present invention further discloses a camera system, comprises a base; a first camera, disposed on the base, constantly facing toward a first direction, and configured to capture a wide-angle image; at least a second camera, disposed on the base, and controlled to rotate around the first camera; and a controller, coupled to the first camera and the at least a second camera, configured to identify at least an image object in the wide-angle image and generate a plurality of control signals to steer the at least a second camera such that at least a moving object is within at least a field of view of the at least a second camera; wherein the at least an image object is corresponding to the at least a moving object in an environment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a camera system according to an embodiment of the present invention.

FIG. 2 is a schematic diagram of a display device according to the embodiment of the present invention.

FIG. 3 is a structural diagram of the camera system according to the embodiment of the present invention.

FIG. 4 is a schematic diagram of a surveillance process according to the embodiment of the present invention.

FIG. 5 is a schematic diagram of a distortion curve.

FIG. 6 is a schematic diagram of a zooming process according to the embodiment of the present invention.

FIG. 7 is a schematic diagram of a surveillance process according to the embodiment of the present invention.

FIG. 8 is a schematic diagram of a zooming process according to the embodiment of the present invention.

FIG. 9 is a structural diagram of the camera system according to the embodiment of the present invention.

FIG. 10 is a schematic diagram of a display device according to the embodiment of the present invention.

### DETAILED DESCRIPTION

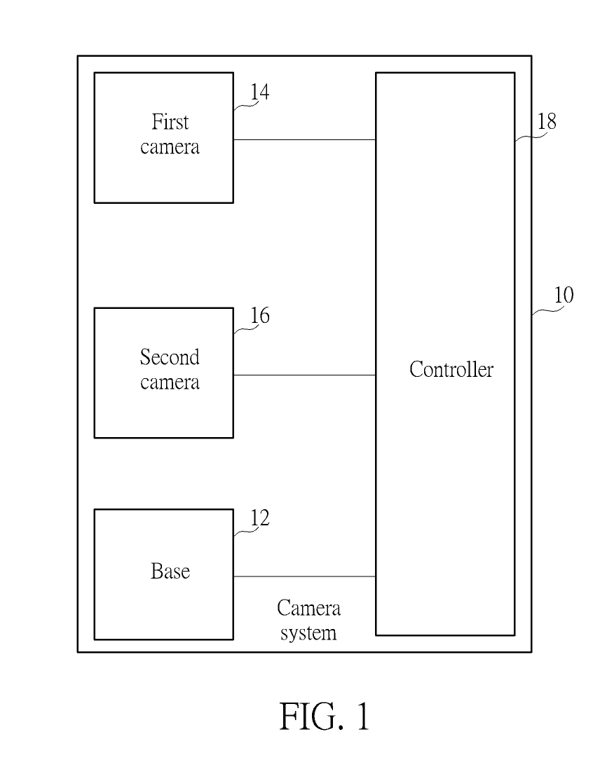

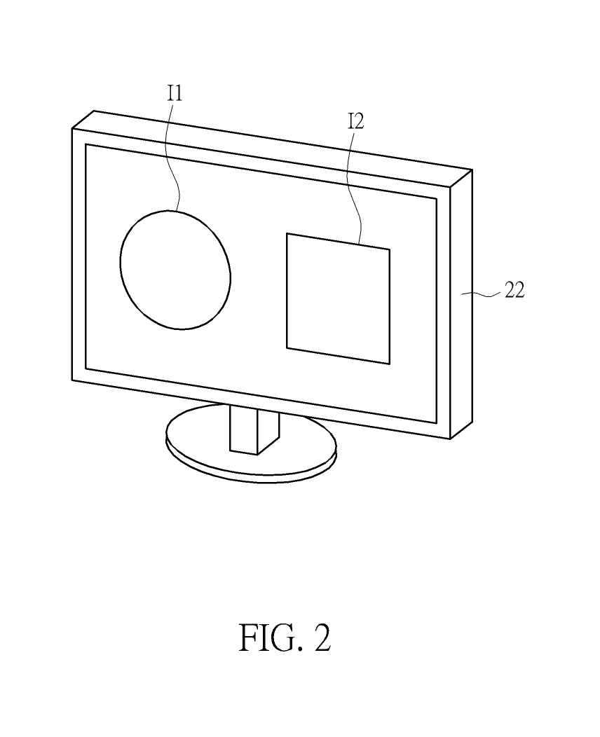

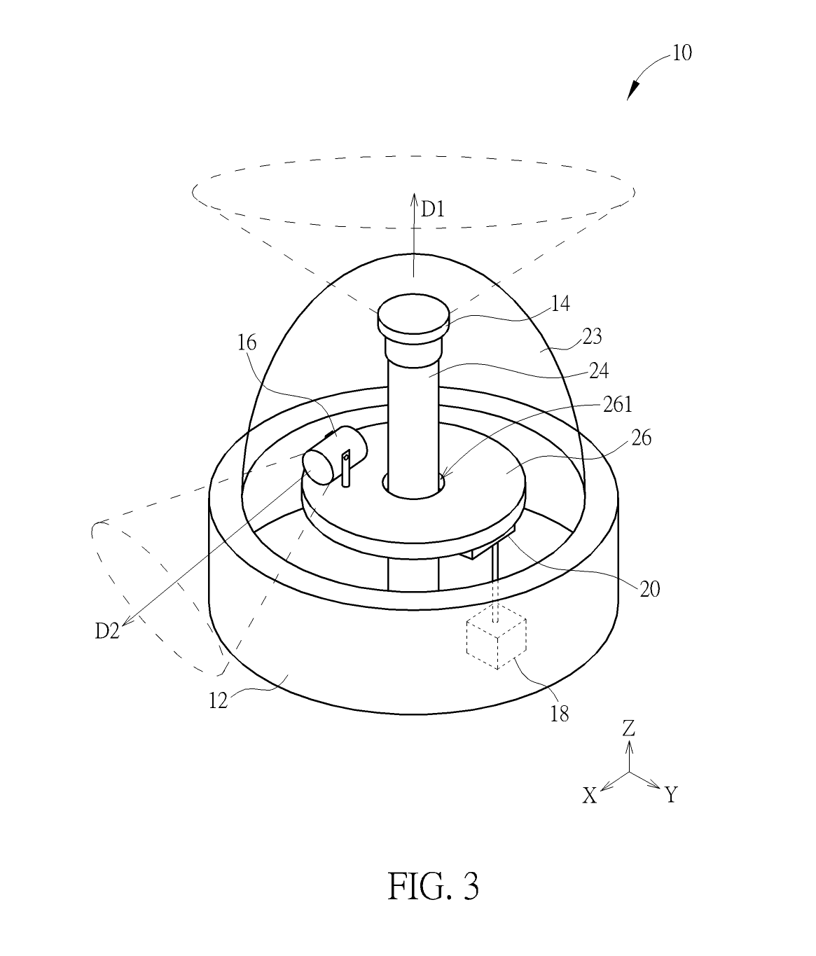

Please refer to FIG. 1 to FIG. 3. FIG. 1 is a functional block diagram of a camera system 10 according to an embodiment of the present invention. FIG. 2 is a diagram of a display device 22 applied to the camera system 10 according to the embodiment of the present invention. FIG. 3 is a structural diagram of the camera system 10 according to the embodiment of the present invention. The camera system 10 comprises abase 12, a first camera 14, a second camera 16, a controller 18, a rotating mechanism 20 and a display device 22. The first camera 14 may be a camera with a wide-angle lens, such as a fisheye camera. The first camera 14 is disposed on the base 12 and constantly faces toward a first direction D1. The first camera 14 is configured to capture a wide-angle image I1 of an environment. The second camera 16 may be a pan-tilt-zoom (PTZ) camera with high resolution and variable focal length. The second camera 16 is configured to capture an interested image I2. The second camera 16 is disposed on the base I2 by the rotating mechanism 20, and adjustably faces toward a second direction D2. The display device 22 is coupled to the first camera 14 and the second camera 16. The display device 22 displays the wide-angle image I1 captured by the first camera 14 and the interested image I2 captured by the second camera 16, where the wide-angle image I1 may be a circular image of the environment. The rotating mechanism 20 may be a slide rail mechanism or a gear mechanism. The controller 18 may be coupled to the first camera 14, the second camera 16, the rotating mechanism 20 and the display device 22. The controller 18 is configured to generate control signals for the rotating mechanism 20 and the second camera 16, so as to steer the second camera 16.

Furthermore, the base 12 includes a central portion 24 and a rotary portion 26. The central portion 24 may be an upright structure, and the rotary portion 26 may be an annular holder or an arc holder that moves along a track encircling the upright structure. The first camera 14 is disposed on the central portion 24 without rotary/shift movement. The second camera 16 is disposed on the rotary portion 26, and may encircle around the first camera 14 by revolution of rotary portion 26 round the central portion 24. Generally, the rotary portion 26 is preferably a tray with a central hole 261, and the central portion 24 passes through the central hole 261 and is encircled by the rotary portion 26.

In an embodiment, the first camera 14 captures the wide-angle image I1, and the display device 22 displays the wide-angle image I1 captured by the first camera 14. After the user perceives the wide-angle image I1 through the display device 22, if the user is interested in a specific part of the wide-angle image I1 corresponding to an object of interest in the environment, the user may input a directional instruction to the camera system 10. The controller 18 may generate a pan signal and a tilt signal to the rotating mechanism 20 and the second camera 16, such that the second camera 16 is steered to capture the interested image I2 of the object of interest in the environment.

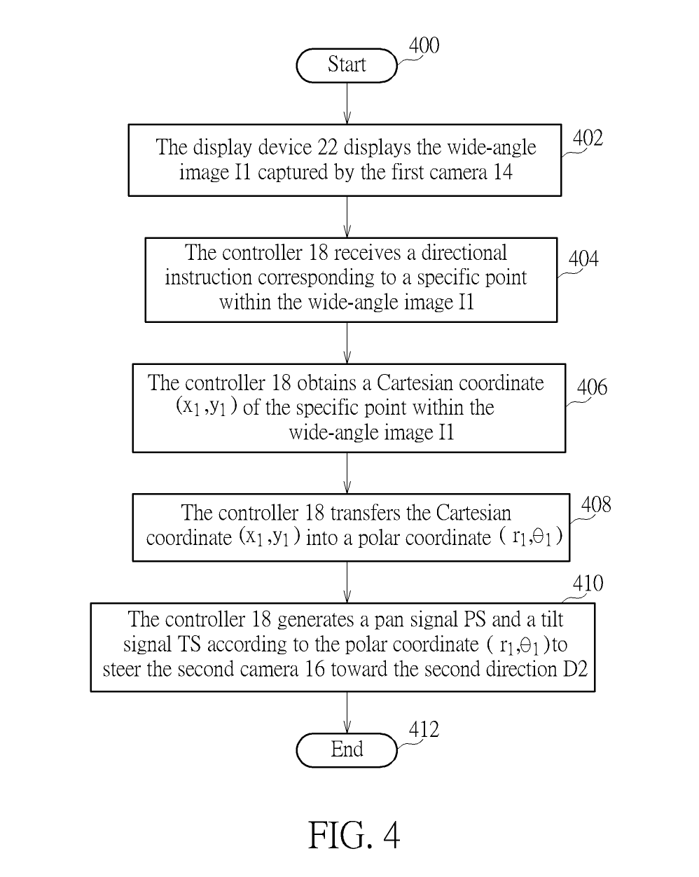

Operations of the camera system 10 steering the second camera 16 to capture the interested image I2 of the object of interest in the environment may be referred to FIG. 4, which is a schematic diagram of a surveillance process 40 according to an embodiment of the present invention. The surveillance process 40 is executed by the camera system 10. The surveillance process 40 comprises following steps:

Step 400: Start.

Step 402: The display device 22 displays the wide-angle image I1 captured by the first camera 14.

Step 404: The controller 18 receives a directional instruction corresponding to a specific point within the wide-angle image I1.

Step 406: The controller 18 obtains a Cartesian coordinate (x₁,y₁) of the specific point within the wide-angle image I1.

Step 408: The controller 18 transfers the Cartesian coordinate (x₁,y₁) into a polar coordinate (r₁,θ₁).

Step 410: The controller 18 generates a pan signal PS and a tilt signal TS according to the polar coordinate (r₁,θ₁) to steer the second camera 16 toward the second direction D2.

Step 412: End.

According to the surveillance process 40, the camera system 10 is able to steer the second camera 16 so as to capture the interested image I2 of the object of interest in the environment according to the directional instruction. Specifically, in Step 402, the display device 22 displays the wide-angle image I1 captured by the first camera 14, where the wide-angle image I1 may be a circular image of the environment. In Step 404, the directional instruction, inputted by the user, may be a mouse click command pointing at the specific point within the wide-angle image I1 on the display device 22, where the mouse click command is inputted by the user via a mouse coupled to the display device 22. The directional instruction may also be a touch command pointing at the specific point within the wide-angle image I1, where touch command is inputted via a finger of the user, if the display device 22 is a touch panel with touch sensing capability.

After the controller 18 receives the directional instruction, in Step 406 and Step 408, the controller 18 obtains the Cartesian coordinate (x₁,y₁) of the specific point within the wide-angle image I1 and transfers the Cartesian coordinate (x₁,y₁) into the polar coordinate (r₁,θ₁) by computing r₁=\sqrt{x₁²+y₁²} and θ₁=tan⁻¹ (x₁/y₁).

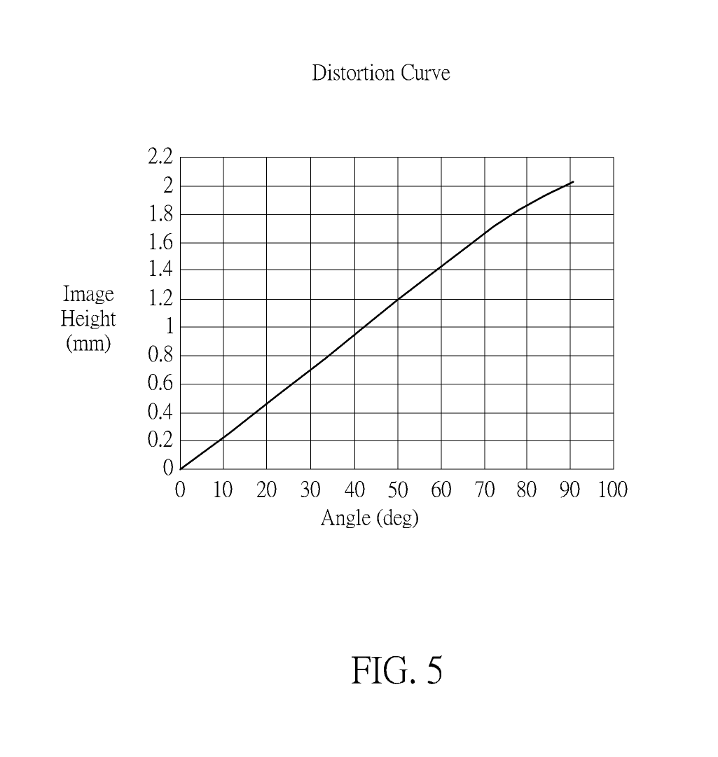

In Step 410, the controller 18 generates the pan signal PS and the tilt signal TS according to the polar coordinate (r₁,θ₁) to steer the second camera 16 toward the second direction D2. The pan signal represents an angle which the second camera 16 should be rotated with respect to the central portion 24. The pan signal PS may be generated by computing PS=σ₁+θ₀, where θ₀ is a default value. The tilt signal TS represents an angle between the first direction D1 and the second direction D2 in a vertical plane. The tilt signal TS may be determined by r₁ of the polar coordinate (r₁,θ₁) and a distortion curve. The distortion curve represents an amount of distortion caused by the wide-angle lens, and an exemplary distortion curve is illustrated in FIG. 5. The tilt signal TS may be generated by computing TS=r₁/D₁+r₀, where D₁ represents an amount of distortion corresponding to and r₀ is a default value.

After the pan signal PS and the tilt signal TS are generated, the pan signal PS may be delivered to the rotating mechanism 20 and the tilt signal TS may be delivered to the second camera 16, such that the second camera 16 is steered toward the second direction D2 to capture the interested image I2 of the object of interest in the environment.

Notably, the user is not limited to the mouse click command or the touch command pointing at the specific point within the wide-angle image I1. The user may select a specific rectangle via a mouse within the wide-angle image I1 displayed on the display device 22. The controller 18 may interpret a relative location of the rectangular zone within the wide-angle image I1 selected by the user as the direction instruction. Meanwhile, the controller 18 may also interpret a size of the specific rectangle as a zooming instruction. According to the zooming instruction, the controller 18 may generate a zoom signal for the second camera 16. The second camera 16 may adjust a focal length thereof, such that a field of view (FOV) of the second camera 16 is corresponding to the specific rectangle within the wide-angle image I1, i.e., the interested image I2 captured by the second camera 16 represents a high resolution image corresponding to the specific rectangle.

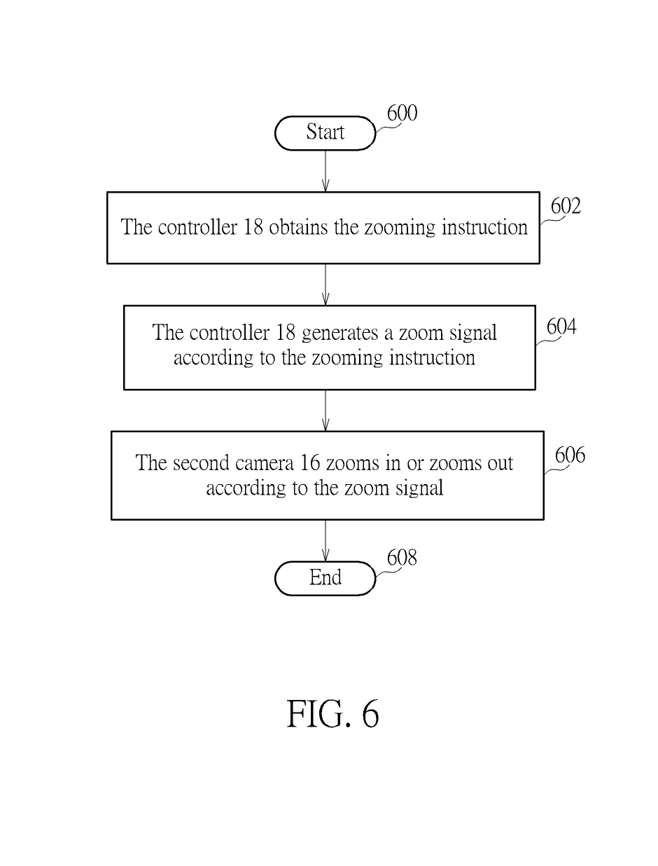

Notably, the user is not limited to select the specific rectangle such that the controller 18 interprets the size of the specific rectangle as the zooming instruction and the second camera 16 zooms in or zooms out accordingly. The user may input a mouse scrolling up/down command via a scrolling wheel of a mouse as the zooming instruction. The user may input an extending gesture or a shrinking gesture on the display device 22, if the display device 22 has touch sensing capability. Operations of the camera system 10 controlling the second camera 16 to zoom in or zoom out can be summarized as a zooming process 60, which is illustrated in FIG. 6. The zooming process 60 is executed by the camera system 10. The zooming process 60 comprises following steps:

Step 600: Start.

Step 602: The controller 18 obtains the zooming instruction.

Step 604: The controller 18 generates a zoom signal according to the zooming instruction.

Step 606: The second camera 16 zooms in or zooms out according to the zoom signal.

Step 608: End.

Detail operations of the zooming process 60 may be referred to the paragraph stated in the above, which is not narrated herein. According to the zooming process 60, the interested image I2 captured by the second camera 16 would be a clear and high resolution vision of the object of interest in the environment.

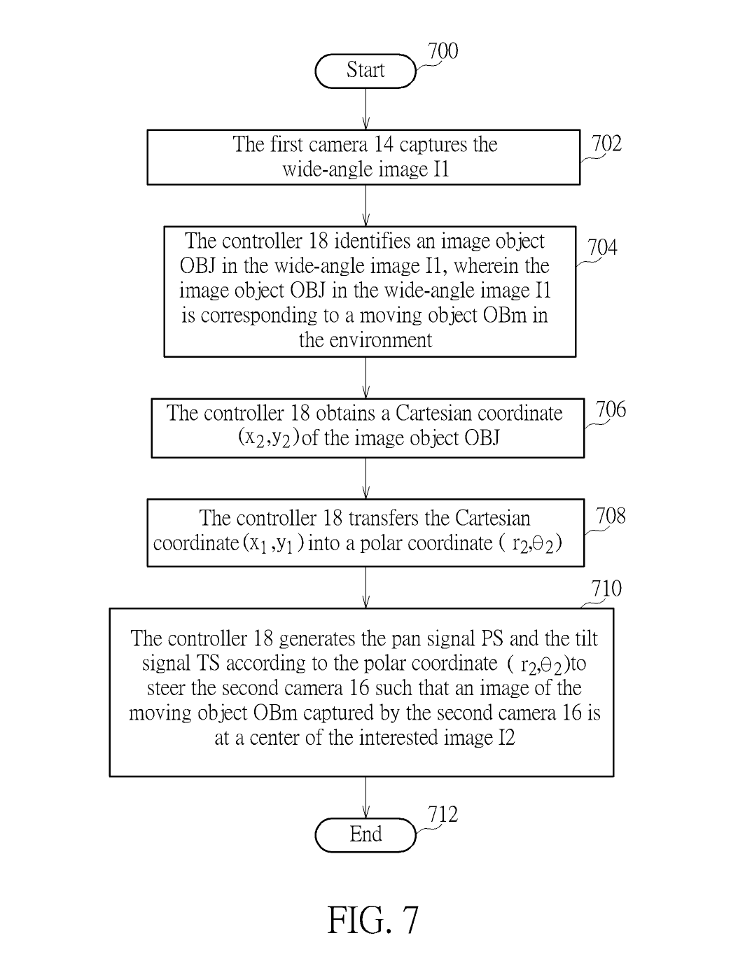

Furthermore, in another embodiment, the camera system 10 may track a moving object in the environment. Operations of the camera system 10 tracking the moving object in the environment may be referred to FIG. 7, which is a schematic diagram of a surveillance process 70 according to an embodiment of the present invention. The surveillance process 70 is executed by the camera system 50. The surveillance process 70 comprises following steps:

Step 700: Start.

Step 702: The first camera 14 captures the wide-angle image

Step 704: The controller 18 identifies an image object OBJ in the wide-angle image I1, wherein the image object OBJ in the wide-angle image I1 is corresponding to a moving object OBm in the environment.

Step 706: The controller 18 obtains a Cartesian coordinate (x₂,y₂) of the image object OBJ.

Step 708: The controller 18 transfers the Cartesian coordinate (x₂,y₂) into a polar coordinate (r₂,θ₂).

Step 710: The controller 18 generates the pan signal PS and the tilt signal TS according to the polar coordinate (r₂,θ₂) to steer the second camera 16 such that an image of the moving object OBm captured by the second camera 16 is at a center of the interested image I2.

Step 712: End.

According to the surveillance process 70, the camera system 10 is able to steer the second camera 16 to track the moving object OBm in the environment. Specifically, in Step 702, the image object OBJ may be identified by the controller 18 by an object recognition technique. The object recognition technique is known by those skilled in the art and not narrated herein. In Step 704, the Cartesian coordinate (x₂,y₂) of the image object OBJ is a representative of the image object OBJ, e.g., the Cartesian coordinate (x₂,y₂) may be a Cartesian coordinate of a center of the image object OBJ.

In Step 710, the controller 18 generates the pan signal PS and the tilt signal TS, so as to steer the second camera 16 such that the image of the moving object OBm captured by the second camera 16 is substantially at the center of the interested image I2. In other words, the controller 18 generates the pan signal PS and the tilt signal TS to steer the second camera 16 such that the moving object OBm is within the FOV of the second camera 16 and substantially at a center of the FOV of the second camera 16. The rest steps of the surveillance process 70 are similar to the surveillance process 40, which may be referred to the paragraph stated in the above and not narrated herein.

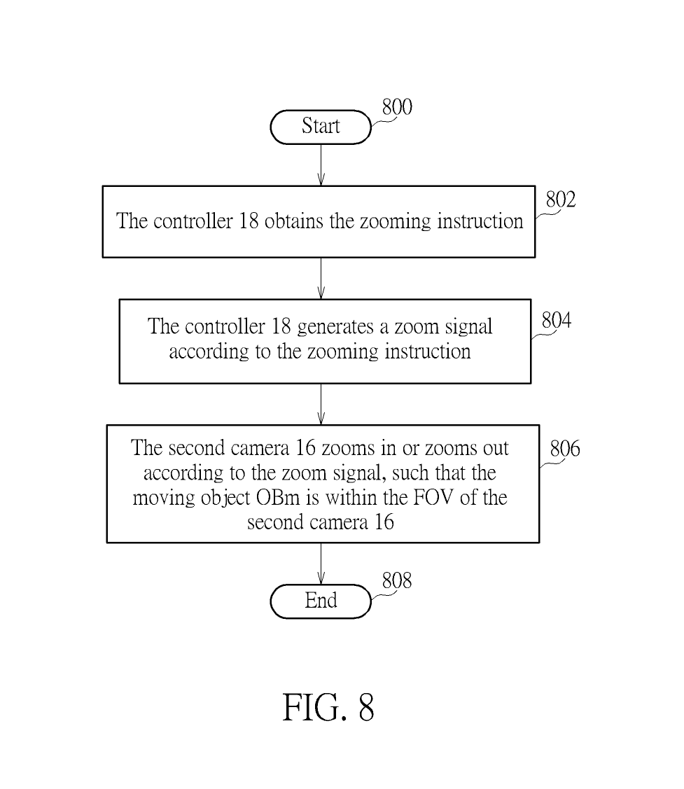

Furthermore, if the moving object OBm is substantially at the center of the FOV of the second camera 16 but a part of the moving object OBm is out of the FOV of the second camera 16, the camera system 10 may generate a zooming signal to control the second camera 16 to zoom out, so as to capture the image of the moving object OBm entirely. In addition, the camera system 10 may generate the zooming signal to control the second camera 16 to zoom in or zoom out, such that a size of the image of the moving object OBm is substantially kept as a specific portion of the interested image I2, where the specific portion may be specified by system requirements or by the user. Operations of the camera system 10 controlling the second camera 16 to zoom in or zoom out to track the moving object OBm can be summarized as a zooming process 80, which is illustrated in FIG. 8. The zooming process 80 is executed by the camera system 10. The zooming process 80 comprises following steps:

Step 800: Start.

Step 802: The controller 18 obtains the zooming instruction.

Step 804: The controller 18 generates a zoom signal according to the zooming instruction.

Step 806: The second camera 16 zooms in or zooms out according to the zoom signal, such that the moving object OBm is within the FOV of the second camera 16.

Step 808: End.

The zooming process 80 is similar to the zooming process 60, and detail operations of the zooming process 80 may be referred to the paragraph stated in the above, which is not narrated herein. According to the zooming process 80, the focal length of the second camera 16 is adjusted according to the zoom signal, such that the moving object OBm is within the FOV of the second camera 16.

Notably, the embodiments stated in the above are utilized for illustrating the concept of the present invention. Those skilled in the art may make modifications and alternations accordingly, and not limited herein. For example, the rotating mechanism 20 is not limited to be the slide rail mechanism or the gear mechanism. The rotating mechanism 20 may be any mechanical mechanism capable of stably rotating the second camera 16, which conforms to the scope of the present invention. In addition, the wide-angle image I1 captured by the first camera 14 is not limited to be the circular image. The wide-angle image I1 may also be a 360° panorama image. Notably, when the wide-angle image I1 is the 360° panorama image, the controller 18 may obtain the polar coordinate (r₁,θ₁) of the specific point directly, i.e., there is no need for the controller 18 to transform the Cartesian coordinate into the polar coordinate, which conforms to the scope of the present invention.

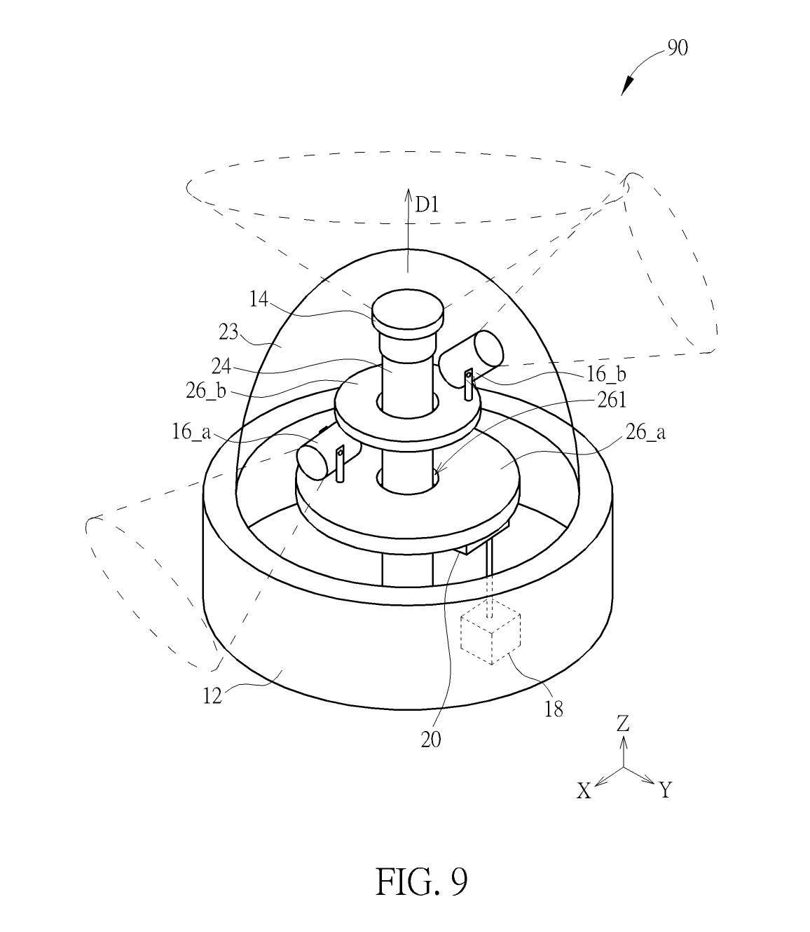

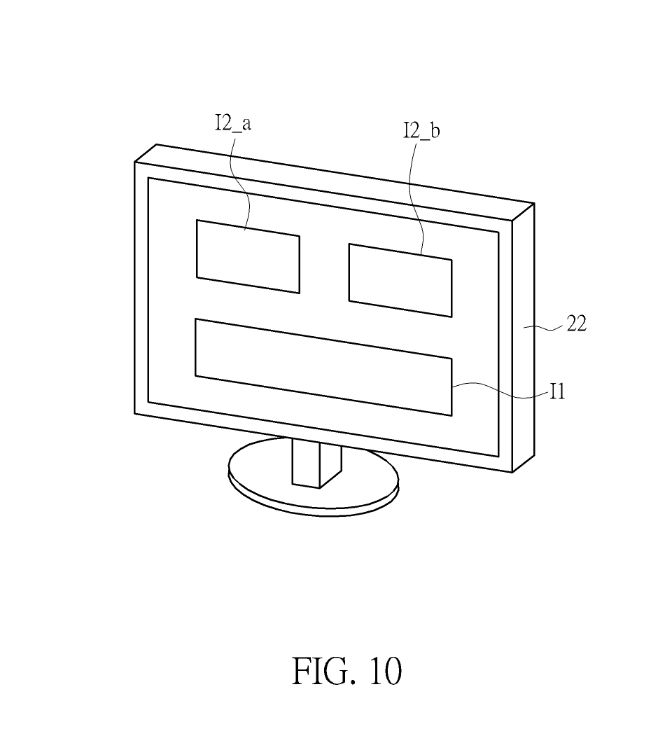

Furthermore, the camera system of the present invention may comprise a plurality of second cameras. For example, please refer to FIGS. 9 and 10. FIG. 9 is a structural diagram of the camera system 90 according to the embodiment of the present invention. FIG. 10 is a diagram of the display device 22 applied to the camera system 90 according to the embodiment of the present invention. The camera system 90 is similar to the camera system 10, and thus, same components are denoted by the same symbols. Different from the camera system 10, the camera system 90 comprises second cameras 16_{—}a, 16_{—}b and rotary portions 26_{—}a, 26_{—}b. The second cameras 16_{—}a, 16_{—}b are configured to capture interested image I2_{—}a, I2_{—}b. The camera system 90 may obtain two different directional instructions and two different zooming instructions corresponding to the second cameras 16_{—}a, 16_{—}b, respectively. In addition, the camera system 90 may also be able to track two different moving objects by the second cameras 16_{—}a, 16_{—}b, respectively. Detail operations are similar to the surveillance processes 40, 70 and the zooming processes 60, 80, which are not narrated herein. Notably, in FIG. 10, the wide-angle image I1 herein is a 360° panorama image, which may be obtained by applying a de-wrapping algorithm on a circular image captured by the first camera 14 as the fisheye camera. The de-wrapping algorithm is known by those skilled in the art, which are not narrated herein.

In summary, the camera system of the present invention is able to monitor a full view of an environment via the first camera and to provide high resolution images of interest objects or moving objects of the environment via the second cameras as well.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A surveillance method, utilized in a camera system, the camera system comprising a display device, a controller, a first camera disposed fixedly on a base of the camera system and constantly facing toward a first direction, and at least a second camera disposed on the base and controlled by the controller to rotate around the first camera, the surveillance method comprising:
the display device displaying a wide-angle image captured by the first camera;
the controller receiving at least a directional instruction corresponding to at least a specific part of the wide-angle image; and
the controller generating a plurality of control signals to steer the at least a second camera toward at least a second direction according to the at least a directional instruction.

2. The surveillance method of claim 1, wherein the step of the controller generating the plurality of control signals to steer the at least a second camera toward the at least a second direction according to the at least a directional instruction comprises:
the controller obtaining at least a polar coordinate of the at least a specific part; and
the controller generating at least a pan signal and at least a tilt signal according to the at least a polar coordinate.

3. The surveillance method of claim 2, wherein the step of the controller obtaining the at least a polar coordinate further comprises:
the controller obtaining at least a Cartesian coordinate of the at least a specific part;
the controller transferring the at least a Cartesian coordinate into the at least a polar coordinate.

4. The surveillance method of claim 2, further comprising:
the controller generating the at least a tilt signal according to the at least a polar coordinate and a distortion curve.

5. The surveillance method of claim 1, further comprising:
the controller obtaining at least a zooming instruction;
the controller generating at least a zoom signal according to the at least a zooming instruction; and
the at least a second camera zooming in or zooming out according to the at least a zoom signal.

6. A camera system, comprising:
a base;
a first camera, disposed on the base, constantly facing toward a first direction, and configured to capture a wide-angle image;
at least a second camera, disposed on the base, adjustably facing toward at least a second direction, and controlled to rotate around the first camera;
a display device, coupled to the first camera and the at least a second camera, configured to display the wide-angle image; and
a controller, coupled to the display device, the first camera and the at least a second camera, configured to generate a plurality of control signals to steer the at least a second camera toward at least a second direction according to at least a directional instruction.

7. The camera system of claim 6, further comprising:
a rotating mechanism coupled to the controller and the at least a second camera, configured to rotate the at least a second camera relative to the base.

8. The camera system of claim 6, wherein the base comprises a central portion and at least a rotary portion, the first camera is disposed on the central portion, the at least a second camera apparatus is disposed on the at least a rotary portion, and the at least a rotary portion revolves with respect to the central portion.

9. The camera system of claim 7, wherein the central portion is an upright structure, the at least a rotary portion is an annular holder or an arc holder encircling the upright structure.

10. The camera system of claim 6, wherein the controller obtains at least a polar coordinate of the at least a specific part, and generates at least a pan signal and at least a tilt signal according to the at least a polar coordinate or a distortion curve.

11. The camera system of claim 6, wherein the controller obtains at least a Cartesian coordinate of the at least a specific part, transfers the at least a Cartesian coordinate into at least a polar coordinate, and generates at least a pan signal and at least a tilt signal according to the at least a polar coordinate or a distortion curve.

12. The camera system of claim 6, wherein the controller obtains at least a zooming instruction, the controller generates the at least a zoom signal to the at least a second camera, and the at least a second camera zooms in or zooms out according to the at least a zoom signal.

13. A surveillance method, utilized in a camera system, the camera system comprising a controller, a first camera disposed fixedly on abase of the camera system and constantly facing toward a first direction, and at least a second camera disposed on the base and controlled to rotate around the first camera, the surveillance method comprising:
the first camera capturing a wide-angle image;
the controller identifying at least an image object in the wide-angle image, where the at least an image object is corresponding to at least a moving object in an environment; and
the controller generating a plurality of control signals to steer the at least a second camera such that the at least a moving object is within at least a field of view of the at least a second camera.

14. The surveillance method of claim 13, wherein the step of the controller generating the plurality of control signals to steer the at least a second camera comprises:
the controller obtaining at least a polar coordinate; and
the controller generating at least a pan signal and at least a tilt signal according to the at least a polar coordinate.

15. The surveillance method of claim 14, further comprising:
the controller generating the at least a tilt signal according to the at least a polar coordinate and a distortion curve.

16. The surveillance method of claim 14, further comprising:
the controller generating the at least a pan signal and the at least a tilt signal such that the at least a moving object is substantially at a center of the at least a field of view of the at least a second camera.

17. The surveillance method of claim 13, further comprising:
the controller obtaining at least a zoom signal; and
the at least a second camera zooming in or zooming out according to the at least a zoom signal, such that the at least a moving object is within the at least a field of view of the at least a second camera.

18. A camera system, comprising:
a base;
a first camera, disposed on the base, constantly facing toward a first direction, and configured to capture a wide-angle image;
at least a second camera, disposed on the base, and controlled to rotate around the first camera; and
a controller, coupled to the first camera and the at least a second camera, configured to identify at least an image object in the wide-angle image and generate a plurality of control signals to steer the at least a second camera such that at least a moving object is within at least a field of view of the at least a second camera;
wherein the at least an image object is corresponding to the at least a moving object in an environment.

19. The camera system of claim 18, further comprising:
a rotating mechanism coupled to the controller and the at least a second camera, configured to rotate the at least a second camera relative to the base.

20. The camera system of claim 18, wherein the base comprises a central portion and at least a rotary portion, the first camera is disposed on the central portion, the at least a second camera apparatus is disposed on the at least a rotary portion, and the at least a rotary portion revolves with respect to the central portion.

21. The camera system of claim 20, wherein the central portion is an upright structure, the at least a rotary portion is an annular holder or an arc holder encircling the upright structure.

22. The camera system of claim 18, wherein the controller obtains at least a polar coordinate, and generates at least a pan signal and at least a tilt signal according to the at least a polar coordinate or a distortion curve.

23. The camera system of claim 22, wherein the controller generates the at least a pan signal and the at least a tilt signal such that the at least a moving object is substantially at a center of the at least a field of view of the at least a second camera.

24. The camera system of claim 22, wherein the controller obtains at least a zoom signal, and the at least a second camera zooms in or zooms out according to the at least a zoom signal, such that the at least a moving object is within the at least a field of view of the at least a second camera.
